(19) United States
(12) Patent Application Publication
(10) Pub. No.: US 2007/0230510 A1
(43) Pub. Date: Oct. 4, 2007

(54) System and method for synchronizing base stations in communication system

(75) Inventors: Cheol-Woo You, Seoul (KR); Sang-Hoon Lee, Seoul (KR); Eung-Sun Kim, Suwon-si (KR); Jong-Hyung Kwun, Seoul (KR); Chi-Hyun Park, Suwon-si (KR); Sung-Ho Jeon, Suyeong-gu (KR); Chang-Wook Ahn, Seo-gu (KR); Sung-Hyun Cho, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/701,986

(22) Filed: Feb. 2, 2007

(30) Foreign Application Priority Data
Feb. 2, 2006 (KR) 2006/10246

(51) Int. Cl. H04J 3/06

(52) U.S. Cl. 370/503

(57) ABSTRACT

Disclosed is a method and system for synchronizing base stations in a communication system. A mobile station receives reference base station information and base station group information, selects a synchronization correction-requiring base station from among a plurality of base stations included in a base station group corresponding to the base station group information, detects a timing offset based on reference signals received from the reference base station and synchronization correction-requiring base station, and transmits the timing offset to the synchronization correction-requiring base station so as to enable the synchronization correction-requiring base station to correct synchronization, thereby synchronizing the base stations in consideration of a real channel environment.

### PRIORITY

This application claims priority under 35 U.S.C. 119(a) to an application filed in the Korean Intellectual Property Office on Feb. 2, 2006 and assigned Serial No. 2006-10246, the contents of which are incorporated herein by reference.

### BACKGROUND OF THE INVENTION

1. Field of the Invention

The present invention relates to a system and method for synchronization of base stations in a communication system, and more particularly to a system and method for synchronizing base stations through a mobile station (MS) in a communication system.

2. Descriiption of the Related Art

The next generation communication systems are being designed to provide users with services having various qualities of service (QoSs) with a high transmission speed. An IEEE (Institute of Electrical and Electronics Engineers) 802.16e communication system is a representative next generation communication system. The construction of the IEEE 802.16e communication system will now be described with reference to FIG. 1.

FIG. 1 is a block diagram illustrating the construction of a conventional IEEE 802.16e communication system.

The IEEE 802.16e communication system has a multi-cell structure, that is, has a cell 100 and a cell 150. In addition, the IEEE 802.16e communication system includes a base station 110 controlling the cell 100, a base station 140 controlling the cell 150, and a plurality of MSs 111, 113, 130, 151 and 153. Although it is possible for one cell to be controlled by a plurality of base stations, it is assumed herein that one cell is controlled by one base station, for convenience of description.

As described above, the IEEE 802.16e communication system includes a plurality of base stations(BSs). Although it is necessary to synchronize a plurality of base stations due to various requests of the base stations, the current IEEE 802.16e communication system does not consider any method for synchronizing the base stations at all.

### SUMMARY OF THE INVENTION

Accordingly, the present invention has been made to solve the above-mentioned problems occurring in the prior art, and an object of the present invention is to provide a system and method for synchronizing base stations in a communication system.

Another object of the present invention is to provide a system and method for synchronizing base stations through a mobile station (MS) in a communication system.

To accomplish these objects, in accordance with one aspect of the present invention, a mobile station in a communication system receives reference base station information and base station group information, selects a synchronization correction-requiring base station from among a plurality of base stations included in the base station group corresponding to the base station group information, detects a timing offset based on reference signals received from the reference base station and synchronization correction-requiring base station, and transmits the timing offset to the synchronization correction-requiring base station so as to enable the synchronization correction-requiring base station to correct synchronization, thereby synchronizing the base stations in consideration of a real channel environment.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating the construction of a conventional IEEE 802.16e communication system;

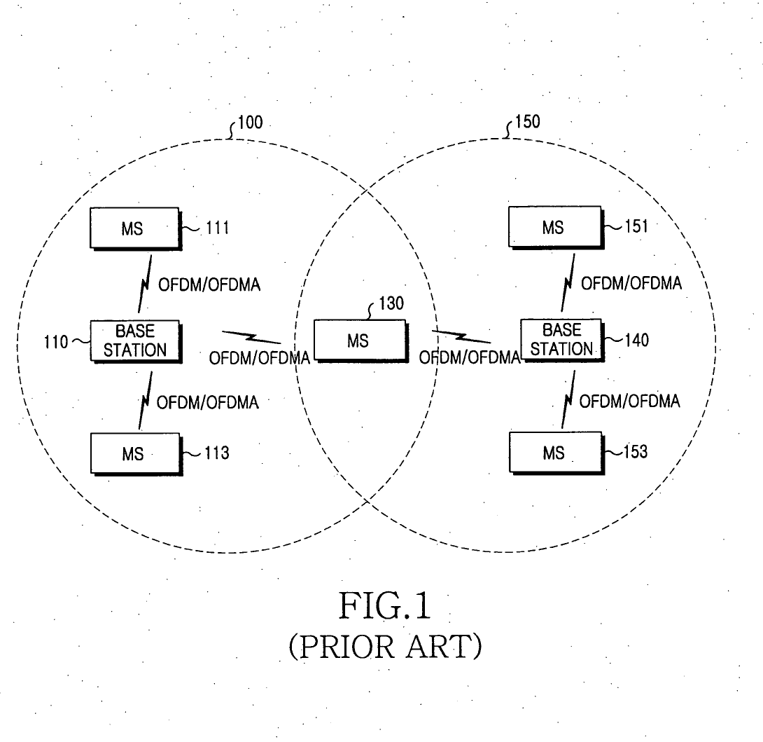

FIG. 2 illustrates the construction of an IEEE 802.16e communication system according to the present invention;

FIG. 3 is a flowchart illustrating a direct base station synchronization operation in the IEEE 802.16e communication system according to the present invention; and

FIG. 4 is a flowchart illustrating an indirect base station synchronization operation in the IEEE 802.16e communication system according to the present invention.

### DETAILED DESCRIPTION OF THE PREFERRED EMBODIMENT

Hereinafter, preferred embodiments of the present invention will be described with reference to the accompanying drawings. In the following description of the embodiments of the present invention, a detailed description of known functions and configurations incorporated herein will be omitted when it may obscure the subject matter of the present invention.

The present invention provides a system and method for synchronizing base stations in a communication system. In addition, the present invention provides a system and method for synchronizing base stations through a mobile station (MS) in a communication system. Hereinafter, for convenience of description, the following description will be given with respect to an IEEE (Institute of Electrical and Electronics Engineers) 802.16e communication system, as an example of a communication system. It is apparent that the system and method for synchronizing base stations of the present invention, can be applied to other communication systems, in addition to the IEEE 802.16e communication system.

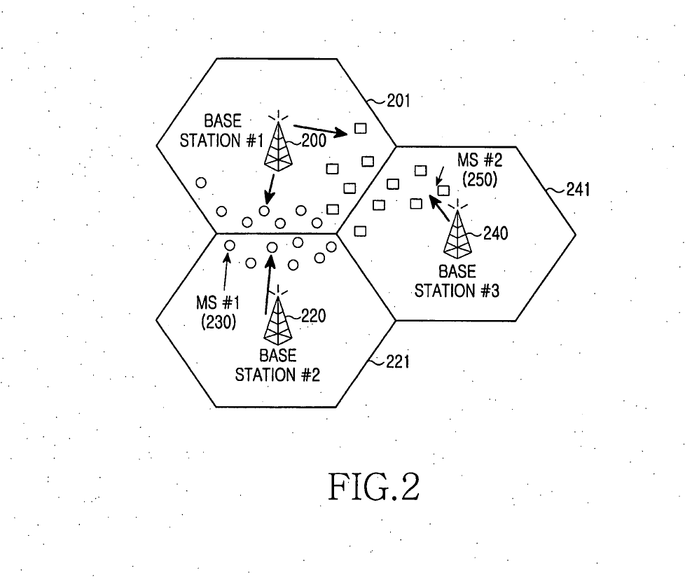

FIG. 2 illustrates the construction of an IEEE 802.16e communication system according to the present invention.

The IEEE 802.16e communication system has a multi-cell structure, that is, includes a plurality of cells (e.g., cell #1 201, cell #2 221 and cell #3 241).

In addition, the IEEE 802.16e communication system includes base station #1 200 controlling cell #1 201, base station #2 220 controlling cell #2 221, base station #3 240 controlling cell #3 241, and a plurality of MSs. Although it is possible for one cell to be controlled by a plurality of base stations, it is assumed herein that one cell is controlled by one base station, for convenience of description. Circles and rectangles illustrated in FIG. 2 represent MSs.

As described above, the IEEE 802.16e communication system includes a plurality of base stations. The present invention provides a system and method for synchronizing the base stations, in which the base stations are grouped into a plurality of base station groups, and base station synchronization is performed by each base station group as a basic unit. Herein, it is apparent that the plurality of base stations may be grouped into one group. Hereinafter, for convenience of description, it is assumed that the base stations 200, 220 and 240, shown in FIG. 2, have been grouped into one base station group.

In the IEEE 802.16e communication system, each base station broadcasts neighbor base station information of the base station through a mobile neighbor advertisement (MOB_NBR_ADV) message or the like. Herein, the MOB_NBR_ADV message includes a plurality of Information Elements (IEs), i.e., an N_NEIGHBORS representing the number of neighbor base stations, a Neighbor BS-ID representing identifiers (IDs) of the neighbor base stations, a preamble ID representing preamble IDs used by the neighbor base stations, a frequency assignment (FA) index representing physical channel numbers of the neighbor base stations, etc.

Also, the present invention provides that the MOB_NBR_ADV message includes reference base station information and base station group information in the form of TLV (Type, Length, Value). Herein, the reference base station refers to a base station which serves as a reference for base station synchronization among a plurality of base stations forming a corresponding base station group, in which a plurality of base stations in the corresponding base station group are controlled to be synchronized with the reference base station. While an embodiment of the present invention is described with reference to the case in which the information about a reference base station and the information about a base station group are included in the MOB_NBR_ADV message in the form of TLV, the reference base station information and the base station group information may be broadcast through separate messages. Also, the reference base station may be randomly determined, or may be determined by the operator of the IEEE 802.16e communication system. The operation of determining the reference base station has no direct relation to the present invention, so a description thereof will be omitted.

As described above, in the IEEE 802.16e communication system, since all base stations broadcast the MOB_NBR_ADV message, it is possible for each MS to receive the MOB_NBR_ADV message and to detect the reference base station of the MS. Hereinafter, the operation for synchronizing the base stations will now be described on the assumption that base station #1 200 is the reference base station of a base station group, which includes base station #1 200, base station #2 220 and base station #3 240.

First, the operation for synchronizing base station #2 220 with base station #1 200 will be described.

In order to synchronize base station #2 220 with base station #1 200, that is, in order for base station #2 220 to perform a synchronization correcting operation, it is necessary to use MSs located in the cell boundary region between base station #1 200 and base station #2 220. The circles shown in FIG. 2 represent MSs located in the cell boundary region between base station #1 200 and base station #2 220. The operation for synchronizing base station #2 220 with base station #1 200 using, for example, MS #1 230, will now be described.

First, MS #1 230 belongs to base station #2 220, and receives service from base station #2 220, so that base station #2 220 serves as a serving base station of MS #1 230. Also, since base station #2 220 broadcasts reference base station information and base station group information as well as neighbor base station information through a MOB_NBR_ADV message, MS #1 230 recognizes that base station #1 200 is a reference base station.

MS #1 230 performs a control operation so that a timing offset between base station #1 200 and base station #2 220 can be transmitted to a specific base station (e.g., base station #2 220), other than the reference base station (i.e., base station #1 200), in the base station group corresponding to the base station group information. In order to transmit the timing offset to base station #2 220, the present invention provides two schemes, that is, a scheme in which MS #1 230 directly transmits the timing offset to base station #2 220 through use of radio resources, and a scheme in which MS #1 230 transmits the timing offset to base station #1 200 by using radio resources and then base station #1 200 transmits the timing offset to base station #2 220 through a backbone (i.e., wired resources).

The specific base station to which MS#1 230 transmits the timing offset, among base stations other than the reference base station in the base station group, corresponds to a base station from which MS#1 230 receives a reference signal (e.g., a pilot signal) having the highest intensity (e.g., the highest Carrier-to-Interference-and-Noise Ratio (CINR)), among the base stations other than the reference base station. Hereinafter, for convenience of description, a specific base station to which the timing offset is transmitted will be referred to as a “synchronization correction-requiring base station.” In addition, a base station synchronization operation in which MS #1 230 transmits a timing offset directly to the synchronization correction-requiring base station will be referred to as a “direct base station synchronization operation,” and a base station synchronization operation in which MS #1 230 transmits a timing offset to a reference base station will be referred to as an “indirect base station synchronization operation.” The synchronization correction-requiring base station corresponds to a base station which is adjacent to the reference base station while belonging to an active set.

The timing offset can be expressed as the following Equation (1).
ΔT_{fb}=Tₐᵣ−Tₐₙ+T_{CP} (1)

In Equation (1), ΔT_{fb} represents the timing offset, T_{CP} represents a compensated delay time based on the CINks of pilot signals which have been received from the reference base station and synchronization correction-requiring base station. That is, T_{CP} represents a time for compensating for an absolute distance between the reference base station and the synchronization correction-requiring base station. Also, Tₐᵣ and Tₐₙ in Equation (1) can be expressed as Equations (2) and (3), respectively.
Tₐᵣ=Tₜᵣ+PR (2)

In Equation (2), Tₜᵣ represents a packet arrival time at a reference base station, and PR represents a propagation delay by the reference base station.
Tₐₙ=Tₜₙ+PN (3)

In Equation (3), Tₜₙ represents a packet arrival time at a synchronization correction-requiring base station, and PN represents a propagation delay by the synchronization correction-requiring base station.

Consequently, base station #2 220, having received a timing offset detected by MS #1 230, performs a synchronization correcting operation according to the timing offset, and informs MS #1 230 that base station #2 220 has completed the synchronization correcting operation when the synchronization correcting operation is finished. Then, MS #1 230 acknowledges the receipt of the synchronization correction completion information to base station #2 220 in response to the synchronization correction completion information reported by base station #2 220. When MS #1 230 has acknowledged the receipt of the synchronization correction completion information to base station #2 220, as described above, the synchronization correcting operation between base station #1 200 and base station #2 220 has been completed.

Second, the synchronizing operation between base station #1 200 and base station #3 240 is similar to that between base station #1 200 and base station #2 220, except that MS #2 250 is established as an MS to be used. Therefore, a detailed description of the synchronizing operation between base station #1 200 and base station #3 240 will be omitted.

As described above, it is possible to synchronize base stations within a base station group on the basis of the reference base station.

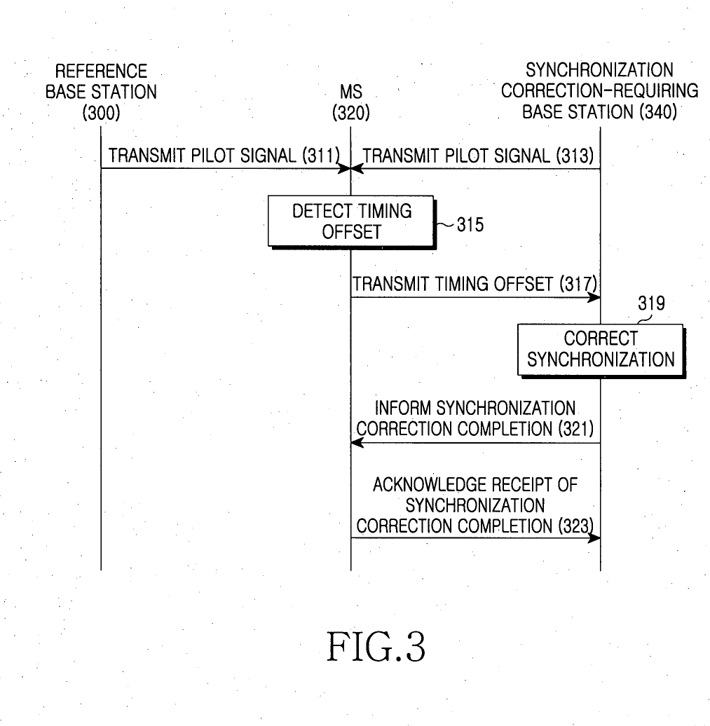

The direct base station synchronization operation in the IEEE 802.16e communication system according to the present invention will now be described with reference to the flowchart of FIG. 3.

Although it is not shown in FIG. 3, all base stations in the IEEE 802.16e communication system broadcast base station information and base station group information through MOB_NBR_ADV messages, so that an MS 320 recognizes the base station information and base station group information. Herein, it should be noted that only a reference base station 300 and a synchronization correction-requiring base station 340 are shown, while other base stations are not shown in FIG. 3. The direct base station synchronization operation between the base stations 300 and 340 will now be described.

Referring to FIG. 3, the reference base station 300 and synchronization correction-requiring base station 340 transmit pilot signals in steps 311 and 313. Since it is assumed in FIG. 3 that the synchronization correction-requiring base station 340 has been determined in advance, the MS 320 receives the pilot signals transmitted from the reference base station 300 and synchronization correction-requiring base station 340, and detects a timing offset based on the pilot signals received from the reference base station 300 and synchronization correction-requiring base station 340 in step 315. Then, the MS 320 transmits the detected timing offset to the synchronization correction-requiring base station 340 in step 317.

The synchronization correction-requiring base station 340 corrects its synchronization itself in step 319, based on the timing offset received from the MS 320. When completing the synchronization correcting operation, the synchronization correction-requiring base station 340 informs the MS 320 of the synchronization correction completion in step 321. When receiving information about the synchronization correction completion from the synchronization correction-requiring base station 340, the MS 320 acknowledges the receipt of the synchronization correction completion information to the synchronization correction-requiring base station 340 in step 323.

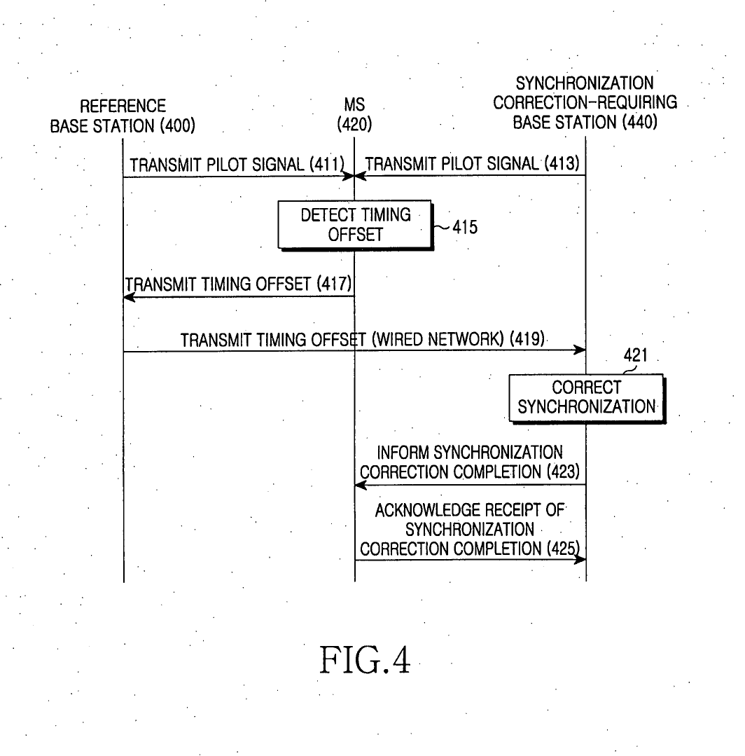

Hereinafter, the indirect base station synchronization operation in the IEEE 802.16e communication system according to the present invention will now be described with reference to the flowchart of FIG. 4.

The operations of steps 411 to 415 are the same as those of steps 311 to 315, so a detailed description thereof will be omitted. An MS 420, which has detected a timing offset through steps 411 to 415, transmits the detected timing offset to a reference base station 400 in step 417.

The reference base station 400 receives the timing offset from the MS 420, and transmits the timing offset to a synchronization correction-requiring base station 440 through a backbone (that is, through a wired network) in step 419.

The synchronization correction-requiring base station 440 corrects the synchronization of the synchronization correction-requiring base station 440 itself based on the timing offset received through the wired network from the reference base station 400 in step 421. When completing the synchronization correcting operation, the synchronization correction-requiring base station 440 informs the MS 420 of the synchronization correction completion in step 423. When receiving information about the synchronization correction completion from the synchronization correction-requiring base station 440, the MS 420 acknowledges the receipt of the synchronization correction completion information to the synchronization correction-requiring Base station 440 in step 425.

As described above, according to the present invention, it is possible to synchronize base stations by using an MS in a communication system. Such base station synchronization using an MS has an advantage in that base stations can be synchronized in consideration of a real channel environment.

While the present invention has been shown and described with reference to certain preferred embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. A method for synchronizing base stations by a mobile station in a communication system, the method comprising:
receiving reference base station information and base station group information;
selecting a synchronization correction-requiring base station from among a plurality of base stations included in a base station group corresponding to the base station group information;
detecting a timing offset based on reference signals received from the reference base station and synchronization correction-requiring base station; and
transmitting the timing offset to the synchronization correction-requiring base station so as to enable the synchronization correction-requiring base station to correct synchronization.

2. The method as claimed in claim 1, wherein selecting the synchronization correction-requiring base station comprises selecting a base station from which a reference signal having a greatest intensity is received from among reference signals of the base stations other than the reference base station in the base station group as the synchronization correction-requiring base station.

3. The method as claimed in claim 1, wherein the timing offset is expressed as:
ΔT_{fb}=Tₐᵣ−Tₐₙ+T_{CP},
wherein ΔT_{fb} represents the timing offset, T_{CP} represents a compensated delay time based on the intensities of the reference signals received from the reference base station and synchronization correction-requiring base station, and Tₐᵣ and Tₐₙ are expressed as:
Tₐᵣ=Tₜᵣ+PR,
wherein Tₜᵣ represents a packet arrival time at the reference base station, and PR represents a propagation delay by the reference base station, and
Tₐₙ=Tₜₙ+PN,
wherein Tₜₙ represents a packet arrival time at the synchronization correction-requiring base station, and PN represents a propagation delay by the synchronization correction-requiring base station.

4. A method for synchronizing base stations by a mobile station in a communication system, the method comprising the steps of:
receiving reference base station information and base station group information;
selecting a synchronization correction-requiring base station from among a plurality of base stations included in a base station group corresponding to the base station group information;
detecting a timing offset based on reference signals received from the reference base station and synchronization correction-requiring base station; and
transmitting the timing offset to the reference base station so as to enable the synchronization correction-requiring base station to correct synchronization.

5. The method as claimed in claim 4, wherein, in the step of selecting the synchronization correction-requiring base station, a base station from which a reference signal having a greatest intensity is received from among reference signals of the base stations other than the reference base station in the base station group is selected as the synchronization correction-requiring base station.

6. The method as claimed in claim 4, wherein the timing offset is expressed as:
ΔT_{fb}=Tₐᵣ−Tₐₙ+T_{CP},
wherein ΔT_{fb} represents the timing offset, T_{CP} represents a compensated delay time based on the intensities of the reference signals received from the reference base station and synchronization correction-requiring base station, and Tₐᵣ and Tₐₙ are expressed as:
Tₐᵣ=Tₜᵣ+PR,
wherein Tₜᵣ represents a packet arrival time at the reference base station, and PR represents a propagation delay by the reference base station, and
Tₐₙ=Tₜₙ+PN,
wherein Tₜₙ represents a packet arrival time at the synchronization correction-requiring base station, and PN represents a propagation delay by the synchronization correction-requiring base station.

7. The method as claimed in claim 4, wherein, in the step of transmitting the timing offset to the reference base station so as to enable the synchronization correction-requiring base station to correct synchronization, the mobile station transmits the timing offset to the reference base station, and then the reference base station transmits the timing offset to the synchronization correction-requiring base station through a backbone so as to enable the synchronization correction-requiring base station to correct synchronization.

8. A system for synchronizing base stations in a communication system, the system comprising:
a mobile station for receiving reference base station informationand base station group information, selecting a synchronization correction-requiring base station from among a plurality of base stations included in a base station group corresponding to the base station group information, detecting a timing offset based on reference signals received from the reference base station and synchronization correction-requiring base station, and then transmitting the timing offset to the synchronization correction-requiring base station; and
the synchronization correction-requiring base station for receiving the timing offset from the mobile station, and correcting synchronization based on the timing offset.

9. The system as claimed in claim 8, wherein the mobile station selects a base station from which a reference signal having a greatest intensity is received from among reference signals of the base stations other than the reference base station in the base station group, as the synchronization correction-requiring base station.

10. The system as claimed in claim 8, wherein the timing offset is expressed as:
ΔT_{fb}=Tₐᵣ−Tₐₙ+T_{CP},
wherein ΔT_{fb} represents the timing offset, T_{CP} represents a compensated delay time based on the intensities of the reference signals received from the reference base station and synchronization correction-requiring base station, and Tₐᵣ and Tₐₙ are expressed as:
Tₐᵣ=Tₜᵣ+PR,
wherein Tₜᵣ represents a packet arrival time at the reference base station, and PR represents a propagation delay by the reference base station, and
Tₐₙ=Tₜₙ+PN,
wherein Tₜₙ represents a packet arrival time at the synchronization correction-requiring base station, and PN represents a propagation delay by the synchronization correction-requiring base station.

11. A system for synchronizing base stations in a communication system, the system comprising:
a mobile station for receiving reference base station information and base station group information, selecting a synchronization correction-requiring base station from among a plurality of base stations included in a base station group corresponding to the base station group information, detecting a timing offset based on reference signals received from the reference base station and synchronization correction-requiring base station, and then transmitting the timing offset to the reference base station;
the reference base station for receiving the timing offset from the mobile station, and transmitting the timing offset to the synchronization correction-requiring base station; and
the synchronization correction-requiring base station for receiving the timing offset from the reference base station, and then correcting synchronization based on the timing offset.

12. The system as claimed in claim 11, wherein the mobile station selects a base station from which a reference signal having a greatest intensity is received from among reference signals of the base stations other than the reference base station in the base station group, as the synchronization correction-requiring base station.

13. The system as claimed in claim 11, wherein the timing offset is expressed as:
ΔT_{fb}=Tₐᵣ−Tₐₙ+T_{CP},
wherein ΔT_{fb} represents the timing offset, T_{CP} represents a compensated delay time based on the intensities of the reference signals received from the reference base station and synchronization correction-requiring base station, and Tₐᵣ and Tₐₙ are expressed as:
Tₐᵣ=Tₜᵣ+PR,
wherein Tₜᵣ represents a packet arrival time at the reference base station, and PR represents a propagation delay by the reference base station, and
Tₐₙ=Tₜₙ+PN,
wherein Tₜₙ represents a packet arrival time at the synchronization correction-requiring base station, and PN represents a propagation delay by the synchronization correction-requiring base station.
